(19) United States
(12) Patent Application Publication
(10) Pub. No.: US 2004/0266302 A1
(43) Pub. Date: Dec. 30, 2004

(54) Absorbent article having odor control properties

(76) Inventors: Anthony L. DiSalvo, Bernardsville, NJ (US); Mary Anne Magee, Hillsborough, NJ (US); Timothy E. Tracy, Pennington, NJ (US); Priscilla M. Tramontana, Yardville, NJ (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/609,772

(22) Filed: Jun. 30, 2003

(51) Int. Cl. B32B 3/26; B32B 3/00; D04H 1/00

(52) U.S. Cl. 442/382; 428/313.3; 428/313.5; 428/320.2; 442/393; 442/417

(57) ABSTRACT

A disposable absorbent article having a member that contains an encapsulated essential oil. The encapsulated essential oil can be in many forms, such as, a film, fiber, filament, particle, coating or mixtures thereof. Regardless of the composition, upon mechanical cracking or breaking of the encapsulation or upon exposure to liquid, fragrance and the related antimicrobial properties contained therein are released.

### FIELD OF THE INVENTION

The present invention relates to an absorbent article containing a fragrant emitting and microbe inhibiting essential oil and methods for making the same.

### BACKGROUND OF THE INVENTION

External disposable absorbent articles, such as, pantiliners, sanitary napkins, interlabial devices, adult incontinence devices, bandages, and diapers are well known in the art. These articles typically have a fluid permeable body-facing side and fluid impermeable garment facing side. Additionally, such articles may include an absorbent layer for retaining fluids therebetween.

One perceived disadvantage of external disposable absorbent articles is their association with odors. Body fluids, including blood and menstrual fluid, contain a variety of substances, including proteins and lipids. Microbial action on proteins has been recognized as a source of malodor. Urine is another body fluid that can be absorbed by sanitary protection products, and microbial activity on urine can form ammonia from urea in excreted urine. Users of disposable absorbent articles often complain of not feeling “fresh” during use of such article due in part to malodors, and hence seek out products that claim to control odor.

There have been a number of technologies developed for controlling odors associated with body fluids, particularly those attributed to perspiration, menstrual fluid degradation products, and urine degradation products. Nearly all of the technologies can be placed into three main subcategories. The first is the use of added materials to absorb or adsorb volatile odors in an effort to restrict their release to the environment surrounding the consumer. Materials or compositions that adsorb and/or absorb volatile odors include sodium bicarbonate, sodium salts of ethylenediamine tetraacetic acid (EDTA), activated carbon, zeolites, and mixtures of sodium bicarbonate, EDTA, and activated carbon. These approaches are disclosed in U.S. Pat. Nos. 4,237,591 and 5,306,487. The second is the use of masking materials, such as, perfumes, and the third is the use of substances to inhibit the production of bodily fluid degradation products. U.S. Pat. No. 5,733,272 discloses absorbent articles containing compositions of moisture-activated encapsulated perfumes and odor-controlling agents, including anti-microbial compounds.

U.S. Pat. No. 6,284,261 discloses the use of essential oils as an additive in absorbent articles to control odors associated with bodily fluids. Such control is described as being accomplished by both odor masking and antimicrobial properties of the essential oils.

Typically, a disposable absorbent article includes polymeric films, fibers, and filaments. These components are used in absorbent and non-absorbent materials that make up the absorbent article. For example, a typical pantiliner includes a fluid permeable cover that is made of a non-woven material or a polymeric film, an absorbent core made from various fibers, and a fluid impermeable backsheet made from a polymeric film. Currently, such materials must have an odor control and/or antimicrobial essential oils added after the film, fiber, particle, filament, coating, and mixtures thereof have been produced.

What is needed is a film, a fiber, a particle, a filament, a coating, and mixtures thereof having an odor control and/or antimicrobial additive that is encapsulated in the film, fiber, particle, filament, coating, and mixtures thereof wherein the properties of the additive are released upon exposure of the film, fiber, and filament to a body fluid or to mechanical breakage or cracking. The present invention solves this need.

### SUMMARY OF THE INVENTION

The object of the present invention is an absorbent article having a member selected from the group consisting of a film, a fiber, a particle, a filament, a coating, and mixtures thereof, wherein the member includes an encapsulated essential oil. The fragrance and antimicrobial properties of the encapsulation essential oil are exposed upon either exposure to fluid, mechanical breaking or cracking, or both.

Such encapsulated essential oil may be deposited within an embossed area of the absorbent article.

### DETAILED DESCRIPTION OF THE INVENTION

The present invention is directed to a disposable absorbent article having a member that contains an encapsulated essential oil. The encapsulated essential oil can be in many forms, such as, a film, fiber, filament, particle, coating or mixtures thereof. Regardless of the composition, upon mechanical cracking or breaking of the encapsulation or upon exposure to liquid, fragrance and the related antimicrobial properties contained therein become released.

It is contemplated in one embodiment herein that after body fluid contacts the body facing surface of the absorbent article of the present invention, the fluid will cause the encapsulation to hydrolyze, which releases the essential oil. In one embodiment of the present invention, once the user has placed the absorbent article on the crotch of her undergarment, movement, such as, walking and sitting, will cause the material to break or crack to release the essential oil.

The encapsulated essential oil of the present invention may be included in any portion of the absorbent article. In one embodiment of the present invention, the encapsulated essential oil is deposited as a coating onto the body facing surface of an absorbent article. In another embodiment, the encapsulated essential oil is in a film coating deposited into embossed areas on the cover of an absorbent article. In another embodiment, the encapsulated essential oil is dispersed within the absorbent material layer of an absorbent article. In another embodiment, the encapsulated essential oil is deposited within a fiber or filament that is used to form a layer of the absorbent article.

Absorbent Material

The absorbent material layer of the present invention may form a body facing layer or surface of an absorbent article. An absorbent material layer may contain any known absorbent materials including, but not limited to, absorbent fibers, such as, cellulose fibers, including, but not limited to, wood pulp, regenerated cellulose fibers, and cotton fibers, rayon fibers and the like; superabsorbent fibers or particles; other naturally occurring absorbent materials, such as, sphagnum or peat moss; and other synthetic absorbent materials, such as, foams and the like. The absorbent material layer may also include one or more of the following: thermoplastic binder fibers, latex binder, or odor-controlling adsorbents. The absorbent material layer may optionally be any material, e.g., tissue, woven, nonwoven, netted material, lace, or foam.

For example, the absorbent material layer can be a fluffy batt cut from a relatively loose web of non-woven fibers having a relatively high absorptive capacity. The absorbent material layer may also be a fibrous batt having an integral densified layer. In such a case, if a backsheet is desired, the absorbent material layer is positioned on the backsheet of the absorbent article so that the densified layer adjoins the backsheet. The densified layer has relatively higher wettability and liquid retentivity than the rest of the aforesaid batt and usually is formed by slightly moistening one surface of the batt and thereafter compressing the moistened surface. The absorbent material layer may also be formed from multiple layers, each having a different density such that the uppermost layer (closest to the body) is less dense than the outer (closest to the garment).

Additionally, the absorbent material layer can be an offline-formed, homogeneously mixed, air-laid layer, roll good laminate or any other offline-formed absorbent composite.

In one embodiment, the absorbent material layer is made of absorbent material that is made from a layer of pulp. In another embodiment, sup erabsorbent polymer (SAP) is mixed with the pulp to form an absorbent composite. This composite may be condensed to form a dense, thin layer. One example of such a material is NovaThin® brand available from Rayonier.

SAP particles are capable of absorbing many times, at least 10, more preferably 15, and still more preferably over 15, their weight in body fluid, under a pressure of 0.5 psi. It should be noted that, in the context of the present invention, there is no restriction that the superabsorbent particles actually be particulate. This expression is intended to cover superabsorbent fibers, and other superabsorbent materials, whatever their form and shape. These superabsorbent particles generally fall into three classes, namely starch graft copolymers, crosslinked carboxymethylcellulose derivates and modified hydrophilic polyacrylates. Examples of such absorbent polymers are hydrolyzed starch-acrylonitrile copolymer graft copolymer, a neutralized starch-acrylic acid graft copolymer, a saponified acrylic acid ester-vinyl acetate copolymer, a hydrolyzed acrylonitrile copolymer or acrylamide copolymer, a modified cross-liked polyvinyl alcohol, a neutralized self-crosslinking polyacrylic acid, a crosslinked polyacrylate salt, carboxylated cellulose, and a neutralized crosslinked isobutylene-malaic anhydride copolymer. In one embodiment of the invention, the superabsorbent particle is a crosslinked polyacrylate salt.

The SAP particles are incorporated into the absorbent material layer in an amount no greater than about 60% on a weight per weight basis. Preferably, they are incorporated in an amount between about 40% and about 0.5% on a weight per weight basis. All specific amounts are within the range explicitly included in this disclosure. In the present context 12% superabsorbent on “a weight per weight basis” is meant to mean 0.12 grams superabsorbent particles per 1 gram of all components comprising the absorbent core.

The absorbent material layer of the present invention may be constructed according to conventional techniques, e.g., by air-laying a mixture of wood pulp fibers and superabsorbent material. All such conventional techniques are within the scope of the present invention. In one embodiment, an absorbent layer is as described in U.S. Pat. 5,866,242, which is herein incorporated by reference in its entirety.

The ratio of SAP to wood pulp may be varied over a wide range. If desired, a layer or multilayer of drylaid type material can be used as the absorbent material layer to form the absorbent core. The absorbent material layer may be made of a SAP of the type used in the art and wood pulp fibers having the desired density.

The absorbent material layer may also include additional materials, such as, wetting agents, odor control material, wetness indicator material, materials for administering or delivering medicaments, such as, encapsulated medicaments, and materials for maintaining skin moisture, such as, encapsulated moisturizers.

Cover

Although not required, the absorbent article of the present invention may include a cover overlaying or unitized with the absorbent material layer. The exterior of the cover would then form the body-facing surface of the absorbent article. The cover may be formed from any fluid pervious material that is comfortable against the skin and permits fluid to penetrate to the absorbent core, which retains the fluid. The cover should retain little or no fluid to provide a relatively dry surface next the skin when in use. A variety of cover materials are known in the art, and any of these may be used. For instance, the cover may be a fibrous non-woven fabric made of fibers or filaments of polymers, such as, polyethylene, polypropylene, polyester, or cellulose, and combinations thereof. Alternatively, the cover may be formed from an apertured polymeric film. The thickness of the cover may vary from about 0.001 to about 0.062 inch, depending on the material chosen.

The liquid permeable material may be a nonwoven fabric, such as, a spunbond, spunlace, airlaid, meltblown, wet laid, thermal bonded, adhesive needle-pushed, resin bonded, and the mixtures thereof, an apertured polymeric film, such as, DRI-WEAVE commercially available from the Procter and Gamble Company, and the like; or any other suitable covering surface that is capable of allowing fluid to permeate and be comfortably worn against the perineum. Various configurations of the material include spunbond-meltblown-spunbond (SMS) and spunbond-meltblown-meltblown-spunbond (SMMS), and similar configurations. The preferred material to be used as the body-contacting surface is a non-woven.

Generally, the optional cover is a single sheet of material having a width sufficient to form the body-facing surface of the absorbent article. In one embodiment, the cover is longer and wider than the absorbent core.

Transfer Layer

The absorbent article of the present invention may include a transfer layer. The transfer layer may be made of any known material that will take up fluid and then distribute and release it to an adjacent absorbent material layer for storage. Preferred transfer layers have a relatively open structure that allows for movement of fluid within the layer. Suitable materials for such transfer layers include any water dispersible material including fibrous webs, water dispersible resilient foams, and the like.

The transfer layer is able to accept fluid and allow passage of the fluid through its mass to be absorbed by an adjacent absorbent core. Thus, transfer layers that are made of hydrophobic, nonabsorbent fibers may be able to accept large volumes of fluid into interfiber void spaces while the fibers themselves do not absorb any significant quantities of fluid. Likewise, open-celled foam structures that are made from nonabsorbent materials may also absorb fluid into the cells of the foam. The walls of the cells, however, do not absorb any fluid. The cumulative spaces within the transfer layer, i.e., the interfiber void spaces in the fibrous transfer layer or the open cells in the foam transfer layer, function much like a container to hold fluid.

Transfer layers that are made from webs of mostly absorbent fibers absorb the fluid as it enters the structure and do not distribute it throughout the rest of the structure as efficiently as webs containing non-absorbent materials. Useful transfer layer fibrous webs include nonabsorbent materials to provide void volume and to allow for free movement of fluid through the structure.

Backsheet

The backsheet of the present invention is a body fluid impervious material, typically referred to as a “barrier,” at least substantially impermeable to liquids, and its exterior forms the garment-facing surface of the absorbent article. The backsheet may be any thin, flexible, body fluid impermeable material, such as a polymeric film, e.g., polyethylene, polypropylene, or cellophane, or a normally fluid pervious material that has been treated to be impervious, such as impregnated fluid repellent paper or non-woven material, including non-woven fabric material, or a flexible foam, such as polyurethane or cross-linked polyethylene. The thickness of the backsheet when formed from a polymeric film typically is about 0.001 to about 0.002 inch.

Optionally, the backsheet may be breathable, i.e., permits vapor to transpire. Known materials for this purpose include nonwoven materials and microporous films in which microporosity is created by, inter alia, stretching an oriented film. Single or multiple layers of permeable films, fabrics, melt-blown materials, and combinations thereof that provide a tortuous path, and/or whose surface characteristics provide a liquid surface repellent to the penetration of liquids may also be used to provide a breathable backsheet.

Useful backsheets include, without limitation, polymeric films or coatings, such as polyolefins (e.g., polyehtylene and polypropylene), polyvinyls (e.g., polyvinyl acetate, polyvinyl chloride, and poyvinylidene chloride), copolymers (e.g., ethylene vinyl acetate), and blends or laminates of one or more of the above polymers; bodily fluid repellant structures such as nonwovens, apertured films, and repellant fiber layers integrated into the bottom layer of the absorbent materials. Useful backsheets include polypropylene and bodily fluid repellant nonwovens. Other useful backsheets barrier is constructed out of polypropylene films. Without limitation, one method to apply essential oils to the backsheet material is by externally coating with a film encapsulating the essential oil on the body-facing side, the garment facing side, or both.

Adhesives

Any construction adhesive may be used to attach the layers into a single absorbent article. One example is HL 1491 available from H.B Fuller and Company (St. Paul, Minn.). The adhesive may be any adhesive now known or developed in future in the art of absorbent article manufacture and may be applied by any method now known or developed in future in the art of absorbent article manufacture.

Secure attachment of absorbent article of the claimed invention to the garment contributes to maintaining the feeling of the user that the absorbent article and the garment are one in the same, i.e., permits the absorbent article to move with the underwear.

The absorbent article of the present invention may be applied to the crotch by placing the garment-facing surface against the inside surface of the crotch of the garment. Various methods of attaching absorbent articles may be used. For example, chemical means, e.g., positioning adhesive, and mechanical attachment means, e.g., clips, laces, ties, and interlocking devices, e.g., snaps, buttons, VELCRO® (Velcro USA, Inc., Manchester, N.H.), zipper, and the like are examples of the various options available to the artisan.

Positioning adhesive may include pressure sensitive adhesive that is applied as strips, swirls, or waves, and the like. As used herein, the term pressure-sensitive adhesive refers to any releasable adhesive or releasable tenacious means. Suitable adhesive compositions, include, for example, water-based pressure-sensitive adhesives such as acrylate adhesives. Alternatively, the adhesive composition may include adhesives based on the following: emulsion or solvent-borne adhesives of natural or synthetic polyisoprene, styrene-butadiene, or polyacrylate, vinyl acetate copolymer or combinations thereof; hot melt adhesives based on suitable block copoylmers—suitable block copolymers for use in the invention include linear or radial co-polymer structures having the formula (A-B)x wherein block A is a polyvinylarene block, block B is a poly(monoalkenyl) block, x denotes the number of polymeric arms and wherein x is an integer greater than or equal to one. Suitable block A polyvinylarenes include, but are not limited to Polystyrene, Polyalpha-methylstyrene, Polyvinyltoluene, and combinations thereof. Suitable Block B poly(monoalkenyl) blocks include, but are not limited to conjugated diene elastomers such as for example polybutadiene or polyisoprene or hydrogenated elastomers such as ethylene butylene or ethylene propylene or polyisobutylene, or combinations thereof. Commercial examples of these types of block copolymers include Kraton™ elastomers from Shell Chemical Company, Vector™ elastomers from Dexco, Solprene™ from Enichem Elastomers and Stereonm from Firestone Tire & Rubber Co.; hot melt adhesive based on olefin polymers and copolymers wherein the olefin polymer is a terpolymer of ethylene and a co-monomers, such as vinyl acetate, acrylic acid, methacrylic acid, ethyl acrylate, methyl acrylate, n-butyl acrylate vinyl silane or maleic anhydride. Commercial examples of these types of polymers include Ateva (polymers from AT plastics), Nucrel (polymers from DuPont), and Escor (from Exxon Chemical).

Where adhesive is used, a release strip may be applied to protect the adhesive on the absorbent article prior to attaching the absorbent article to the crotch. The release strip can be formed from any suitable sheet-like material that adheres with sufficient tenacity to the adhesive to remain in place prior to use but which can be readily removed when the absorbent article is to be used. Optionally, a coating may be applied to the release strip to improve the ease of removabilty of the release strip from the adhesive. Any coating capable of achieving this result may be used, e.g., silicone.

The adhesive applied to the garnent facing side of the absorbent article may be any adhesive now known or developed in future in the art of absorbent article manufacture. As a non-limiting example, pressure sensitive adhesive strips, swirls, or waves may be applied to help maintain the absorbent article in place. As used herein, the term pressure-sensitive adhesive refers to any releasable adhesive or releasable tenacious means. Suitable adhesive compositions, include, for example, water-based pressure-sensitive adhesives such as acrylate adhesives. Alternatively, the adhesive composition may include rapid setting thermoplastic “hot melt,” rubber adhesives, two-sided adhesive tape, and the like.

Adhesives can encapsulate essential oils in accordance with the present invention. The essential oils can readily be dispersed in many adhesive types, such as, hot melts and warm melts. Using adhesive as an encapsulation material can improve the add-on level and placement of essential oils. The adhesive also serves as binder material that can reduce the amount of essential oils lost prior to use.

Additionally, the absorbent core may be coated with a fluid permeable or impermeable material in a discrete pattern. Examples of this type of coating can be found in co-pending application filed concurrently with the present application, entitled ABSORBENT ARTICLE INCLUDING in situ COVER, commonly owned and incorporated herein by reference.

Essential Oils

A typical essential oil is a complex mixture of alcohols, aldehydes, esters, ketones, oxides, phenols, and terpenes. In particular, essential oils are highly concentrated, volatile liquids originating from a single botanical source. In addition the present invention contemplates that other additive may also be useful, for example, a fragrance, e.g., neutralizing counteractant, e.g., Veil from Quest, or any odor emitting substance, including but not limited to essential oils, perfumes, any odor or aromatic emitting compound.

Malodors attributed to bodily fluids are most likely the result of bacteria degrading components residing in the bodily fluids. Bacteria can transform phospholipids into amines and fatty acids, and urea in urine to ammonia. Rosemary oil, for example, is an effective inhibitor of a number of gram positive and gram negative bacteria, such as, but not limited to, Staphylococcus aureus, Eschericia coli, and Pseudomonas aeruginosa. Further to its inhibiting affect on bacteria, rosemary oil also has an inhibiting affect on a variety of fungi and yeast. Of particular interest to feminine hygiene, rosemary oil has been seen to inhibit the growth of Candida albicans.

In addition to its antimicrobial activity, rosemary oil emits a pine-like, camphorous odor. Odor control is thus achieved in that rosemary oil both inhibits the microbial growth that degrades bodily fluid components and provides a pleasant aroma.

Essential oils can be extracted by steam distillation, and other techniques known in the art, from a variety of plant components, including, but not limited to, roots, leaves, bark, flowers and pulp. The majority of the oil-producing plants are represented by 90 species, and these are derived from about 30 different plant families.

The present invention provides an absorbent article having a film, fiber, or filament containing one or more essential oils in an amount effective to provide two functions: emit a pleasant aroma and inhibit microbial growth. Rosemary oil, clove oil, ginger oil, turmeric oil, chamomile oil, lemon grass oil, thyme oil, achillea oil, thulasi oil, clary sage oil, cedar (hinoki) oil, and derivatives, variations, and mixtures thereof, are all suitable for use as the essential oil. Synthetic forms of the oils described above can also be employed in the present invention. A useful essential oil is rosemary oil, which is commercially available from Lorann Oils.

According to one embodiment of the present invention, the essential oil becomes encapsulated during polymerization. One method of incorporating essential oils into the articles is by adding the essential oils with monomers prior to polymerization. After polymerization, the resulting encapsulated essential oil may then be formed into a film, particle, coating, filament, or fiber. The resulting films, particles, filaments, coatings, or fibers can be used to form the elements utilized in the manufacture of disposable absorbent articles. In one embodiment, an essential oil is encapsulated within a clear or transparent film, such as, polyvinyl alcohol.

Methods of encapsulating the essential oil during polymerization are well known to those of ordinary skill in the art and any such method can be used.

The sizes and lengths of particles, fibers, and filaments are those customarily used by those skilled in the art.

The thickness of the coating is dictated on the amount of flexibility desired in the finished article.

Examples of materials that are useful in encapsulating the essential oil in the present invention include water-soluble polymers. A non-limiting list of such polymers now known include alginates, alkyl and hydroxyalkylalkylcellulose, carboxymethylcellulose, carrageenan, gums, e.g., agar, Arabic, ghatti, karaya, tragacanth, hydroxyethylcellulose, hydroxypropylcellulose, locust bean gum, pectins, polyacrylamide, poly(acrylic acid) and it's homologs, polyethylene glycol, poly(ethylene ocide), polyvinylpyrrolidone, pullulan, starch and modifications, tamarind gum, xanthan gum, and mixtures thereof.

A method of adding a film containing at least one essential oil to materials used in disposable absorbent articles of the present invention is to apply the essential oils to a finished product, typically by coating. Simplicity and efficiency are two benefits of using coating techniques. Coating methods that can be used in the present invention include, but are not limited to, dip, slot, spray, melt blown, control coat, and swirl spray.

Alternately, when the encapsulated essential oil of the present invention is in a particle form, the particles can be dispersed throughout the absorbent material, e.g., in the cover or absorbent core.

In general, the amount of essential oil used in the absorbent article is between about 0.1 and about 8 weight percent, more preferably between about 0.2 and about 4 weight percent, and most preferably between about 0.5 and about 1.5 weight percent.

In another embodiment, the film may be colored, with or without a pigment, such as, titanium dioxide. Colors include, but are not limited to, red, orange, yellow, green, blue, indigo, violet, white, black, and mixtures thereof. Color may be imparted according to the present invention though dying and/or pigmentation. Colorants used according to the present invention include dyes and inorganic and organic pigments. The dyes include, but are not limited to, Azo dyes (e.g., Solvent Yellow 14, Disperse Yellow 23, Metanil Yellow), anthraquinone dyes (Solvent Red 111, Disperse Violet 1, Solvent Blue 56, and Solvent Green 3), Xanthene dyes (Solvent Green 4, Acid Red 52, Basic Red 1, and Solvent Orange 63), azine dyes (jet black), and the like.

Inorganic pigments include, but are not limited to, titanium dioxide (white), carbon black (black), iron oxides (red, yellow, and brown), chromium oxide (green), ferric ammonium ferrocyanide (blue), and the like.

Organic pigments include, but are not limited to, diarylide yellow AAOA (Pigment Yellow 12), diarylide yellow AAOT (Pigment Yellow 14), phthalocyanine blue (Pigment Blue 15), lithol red (Pigment Red 49:1), Red Lake C (Pigment Red), and the like.

The disposable absorbent article of the present invention can take a plurality of forms including, but not limited to, pantiliners, sanitary napkins, interlabial devices, adult incontinence devices, bandages, and diapers. The present invention is particularly advantageous for articles designed for managing cervical and urethral discharge. As used here, and throughout the text, sanitary napkin means any feminine hygiene product worn external to the vagina.

Absorbent articles are commercially available in multiple sizes and shapes, and can vary according to individual needs. Without limitation, the common names for the variety of externally worn sanitary napkin products include pantiliners (including those designed for thong-type underwear, g-string or abbreviated crotch-type underwear), full-size pads, and ultrathins.

As used herein, the term thong includes, but is not limited to, thong underwear, thong swimming suit bottom, G-strings, Rio cut underwear, Rio cut swimming suit bottom, Brazilian cut underwear, Brazilian cut swimming suit bottom, and any other garment that exposes the buttocks, having a narrow strip of fabric or a cord that passes between the thighs supported by a waistband, a waist cord, belt or the garment itself

The majority of absorbent articles are either rectangular or hourglass shaped to fit in the crotch of undergarments. Also contemplated herein include symmetrical absorbent articles having parallel longitudinal edges, dog bone- or peanut-shaped, circuvlar, oval and the like. Most products are attached directly to a user's undergarment, and contact the perineum intimately when the undergarments are pulled up. Attachment methods may also include flaps or wings. Alternately, absorbent articles can be attached directly to the body with body adhering adhesives, or held in place against the body from pressures exerted by the labia.

Absorbent articles typically are packaged loosely into a primary package, such as a carton, box or bag, and can have secondary packaging that allows the consumer to transport individual products and protect them from any unwanted environmental affects. The consumer withdraws the ready-to-use article as needed.

Absorbent articles of the present invention are odorless prior to exposure to body fluid or mechanical breaking or cracking.

Additionally, absorbent articles of the present invention may be flushable, that is discardable in a toilet, urinal, or other flushing device made for the purpose of receiving urine or other body exudates and transporting it through a public or private sewage or plumbing system. Flushable articles may be made of biodegradable materials, i.e., those materials that are capable of being broken down especially into innocuous products by the action of living things (such as microorganisms). In addition, flushable articles may break apart, i.e., the article or element exhibits visible changes after being flushed down a standard toilet; the changes may include any visible failures to the integrity of the article or element, such as holes, slits, shreds; breaking apart into smaller sections; dissolving; or a combination thereof.

The absorbent article may include other known materials, layers, and additives, such as, foam, net-like material, medicaments or pharmaceutical agents, moisturizers, odor adsorbents, and the like. The absorbent article can optionally be embossed with decorative designs.

For example, the encapsulated essential oil of the present invention may be useful in the absorbent core, the water dispersible outer shell, or both of the invention described in co-pending application filed concurrently with the present application, entitled DISPOSABLE ABSORBENT ARTICLE, commonly owned and incorporated herein by reference, U.S. Ser. No. 10/______ and a coating can be deposited on the floor area, at least one of the side walls of the embossed area, or both. Such methods are disclosed in co-pending application entitled ENHANCED EMBOSSING AND RELATED METHODS, U.S. Ser. No. 10/______, filed concurrently herewith, which is commonly owned and incorporated herein by reference.

From the foregoing description, one skilled in the art can ascertain the essential characteristics of this invention, and without departing from the spirit and scope thereof, can make various changes and modifications. Embodiments set forth by way of illustration are not intended as limitations on the variations possible in practicing the present invention.

What is claimed:

1. An absorbent article comprising a member selected from the group consisting of a film, a fiber, a particle, a filament, a coating, and mixtures thereof, wherein the member comprises an encapsulated essential oil.

2. An absorbent article of claim 1, wherein the member further comprises a pigment.

3. An absorbent article of claim 1, further comprising a nonwoven, wherein the nonwoven comprises the fiber or the filament.

4. An absorbent article of claim 3, wherein the nonwoven is a spunlace, a spundbond, airlaid, wet laid, thermal bonded, adhesive needle-pushed, meltblown, and mixtures thereof.

5. An absorbent article of claim 4, wherein the nonwoven is a SMS or a SMMS.

6. An absorbent article of claim 1, wherein the member is a particle that is deposited within a nonwoven.

7. An absorbent article of claim 1, wherein the absorbent article further comprising an absorbent material.

8. An absorbent article of claim 1, wherein the absorbent material is a cover layer, an absorbent core, or both.

9. An absorbent article of claim 8, wherein the cover layer comprises a pigment.

10. An absorbent article of claim 7, further comprising a nonwoven, wherein the nonwoven comprises the fiber or the filament.

11. An absorbent article of claim 10, wherein the nonwoven is a spunlace, a spundbond, airlaid, meltblown and mixtures thereof.

12. An absorbent article of claim 11, wherein the nonwoven is a SMS or a SMMS.

13. An absorbent article of claim 7, wherein the member is a particle that is deposited within a nonwoven.

14. An absorbent article of claim 7, wherein the absorbent article further comprises an embossed area having at least one side wall and a floor.

15. An absorbent article of claim 14, wherein the member is a coating or a film that is deposited on the floor of the embossed area.

16. An absorbent article of claim 14, wherein the member is a coating or a film that is deposited on an unembossed area.

17. An absorbent article of claim 15 or 16, wherein the coating or film is water soluble polymer.

18. An absorbent article of claim 17, wherein the water soluble polymer is selected from the group consisting of an alginate, a cellulose, carrageenan, a gum, pectin, polyvinyl alcohol, polyacrylamide, poly(acrylic acid), polyethylene glycol, poly(ethylene ocide), polyvinylpyrrolidone, and mixtures thereof.

19. An absorbent article of claim 1, wherein the encapsulated essential oil is selected from the group consisting of rosemary oil, clove oil, ginger oil, turmeric oil, chamomile oil, lemon grass oil, thyme oil, achillea oil, thulasi oil, clary sage oil, hinoki oil, and mixtures thereof.

20. An absorbent article of claim 18, wherein the encapsulated essential oil is selected from the group consisting of rosemary oil, clove oil, ginger oil, turmeric oil, chamomile oil, lemon grass oil, thyme oil, achillea oil, thulasi oil, clary sage oil, hinoki oil, and mixtures thereof.

21. An absorbent article of claim 20, wherein the polymer is polyvinyl alcohol and the essential oil is rosemary oil.
